(19) United States
(12) Patent Application Publication
(10) Pub. No.: US 2023/0356770 A1
(43) Pub. Date: Nov. 9, 2023

(54) STEER-BY-WIRE STEERING SYSTEM AND METHOD FOR OPERATING A STEER-BY-WIRE STEERING SYSTEM IN A NORMAL OPERATING MODE AND IN A SPECIAL OPERATING MODE

(71) Applicants: thyssenkrupp Presta AG, Eschen (LI); thyssenkrupp AG, Essen (DE)

(72) Inventors: Leonard LAPIS, Sennwald (CH); Dominik LANG, Feldkirch (AT); Miklós ARÁNYI, Rebstein (CH); Akos DOBCSANYI, Mauren (LI)

(73) Assignees: thyssenkrupp Presta AG, Eschen (LI); thyssenkrupp AG, Essen (DE)

(21) Appl. No.: 18/143,480

(22) Filed: May 4, 2023

(30) Foreign Application Priority Data
May 6, 2022 (EP) 22172034.5

(51) Int. Cl. B62D 5/04

(52) U.S. Cl. CPC B62D 5/0463

(57) ABSTRACT

A method of operating a steer-by-wire steering system of a motor vehicle to convert a steering command into a steering movement of steerable wheels of a motor vehicle is disclosed. The method includes sending a control signal to an electric motor of a steering actuator and converting the received control signal into a mechanical movement of the steering actuator by the electric motor, wherein the steering actuator acts on a coupling element, and wherein the electric motor is operated in a generator mode.

### CROSS REFERENCE TO RELATED APPLICATION

This application is a U.S. Non-Provisional that claims priority to European Patent Application No. EP 22172034.5, filed May 6, 2022, the contents of which are incorporated herein by reference.

### FIELD

The present disclosure generally relates to a a steer-by-wire steering system for a motor vehicle with a steering input device by means of which a steering command can be specified.

### BACKGROUND

In a classic steering system for a motor vehicle, a steering command, which is introduced into a steering train by a driver by means of a steering input device, is transmitted by means of a mechanical coupling to a steering gear, where a rotation of at least one steerable wheel corresponding to the steering command is caused. From the prior art it is known, for example from EP 2 353 968 B1, that a classic steering system can be augmented so that an electric motor supports the steering command entered by means of the steering input device by means of an active connection to the steering system. As a result, the torque is reduced which must be applied to the steering input device by a driver of a motor vehicle in order to achieve a specified rotation of the at least one steerable wheel. Nevertheless, there is—even in the event of a failure of the electric motor—a mechanical connection between the steering input device and the at least one steerable wheel, so that steerability of the vehicle is still guaranteed even in the event of electronic problems.

From the prior art, steer-by-wire steering systems for motor vehicles are known as a further development of such electromechanical steering systems. The mechanical coupling between the steering input device and the steering gear is dispensed with here. Instead, the steering command is detected by sensors and converted into an electrical signal, which is then forwarded to an electric motor, which is actively connected to the steering gear, to cause a rotation of the at least one steerable wheel corresponding to the steering command. For example, the publication DE 10 2018 115 329 A1 discloses such a steer-by-wire steering system. Steer-by-wire steering systems offer various advantages. Steer-by-wire steering systems require less installation space, for example. In addition, the required components are mechanically less stressed than the required components in classic steering systems.

In addition to the advantages of such steer-by-wire steering systems, the mechanical decoupling between the steering input device and the steering gear creates new problems that require a reliable solution to ensure safe driving. To better manage these problems, many components of a steer-by-wire steering system are designed redundantly to increase reliability. For example, WO 2019/154903 A1 describes an electromechanical steering system with a redundantly designed control unit.

Nevertheless, there is a need to increase safety when operating a steer-by-wire steering system and to make steer-by-wire steering systems even safer. Thus a need exists to provide a method for operating a steer-by-wire steering system and a steer-by-wire steering system with which increased safety for the driver of a motor vehicle is achieved. In particular, safety is to be increased in the event that the steering actuator of a steer-by-wire steering system no longer responds to a specified steering command.

### BRIEF DESCRIPTION OF THE FIGURES

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a perspective view of an embodiment of a steer-by-wire steering system according to the disclosure.

FIG. 2 is a circuit diagram of an embodiment of an electric motor of a steer-by-wire steering system according to the disclosure with a control unit and a circuit arrangement.

FIG. 3 is a block diagram of an embodiment of a method according to the disclosure for operating a steer-by-wire steering system.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The disclosure relates to a steer-by-wire steering system for a motor vehicle with a steering input device by means of which a steering command can be specified, and with a steering gear including a steering actuator having an electric motor and a coupling element, wherein the electric motor of the steering actuator is designed to receive a control signal and to convert the received control signal into a mechanical movement of the steering actuator to convert a steering command into a steering movement of steerable wheels of a motor vehicle, wherein the steering actuator is designed to act on the coupling element to implement the steering command. Furthermore, the disclosure relates to a method for operating such a steer-by-wire steering system, wherein in a normal operating mode for converting a steering command into a steering movement of steerable wheels of a motor vehicle a control signal is sent to the electric motor of the steering actuator, the electric motor converts the received control signal into a mechanical movement of the steering actuator, wherein the steering actuator acts on the coupling element.

The method provides for operating a steer-by-wire steering system of a motor vehicle, wherein the steer-by-wire steering system comprises a steering input device by means of which a steering command can be specified and a steering gear including a steering actuator and a coupling element which can be driven by an electric motor, wherein in a normal operating mode for converting a steering command into a steering movement of steerable wheels of a motor vehicle, a control signal is sent to the electric motor of the steering actuator, the electric motor converts the received control signal into a mechanical movement of the steering actuator, wherein the steering actuator acts on the coupling element, and wherein the electric motor is operated in a generator mode in a special operating mode. The special operating mode is in particular an operating mode in which the steer-by-wire steering system is operated when a serious fault in the steering system and/or a functional failure in the steer-by-wire steering system is detected. A serious fault or a functional failure that leads to a change to the special operating mode exists in particular if the steering actuator of the steer-by-wire steering system no longer responds to a specified steering command, i.e. a motor vehicle can no longer be steered by means of the steering input device of the steer-by-wire steering system. Due to the fact that the electric motor of the steering actuator is operated in the generator mode in the special operating mode, the electric motor is advantageously used as an electromotive brake, which restricts or damps steering movements of steerable wheels of a motor vehicle. This exploits the fact that there is an active connection between the electric motor of the steering actuator and the steerable wheels of a motor vehicle. So steerable wheels are arranged in particular via tie rods on a rack on which the steering actuator can act. Adjusting the wheel angle of the steered wheels thus leads to a movement of the rack and via the rack to a movement of the steering actuator, which in turn acts on the electric motor. Due to the generator mode, the kinetic energy is converted into electrical energy, which causes the braking or damping effect. Advantageously, the generated electrical energy and thus the damping effect is proportional to the kinetic energy. In particular, uncontrolled “fluttering” of the at least one steerable wheel can thus be prevented. An anti-turn means is advantageously provided for the steerable wheels of a motor vehicle. A motor vehicle can thus advantageously be controlled in an improved manner and can thus stop more safely. Advantageously, directional stability can be realized until the motor vehicle stops.

A further advantageous embodiment provides that the steer-by-wire steering system comprises front-axle steering for adjusting a wheel steering angle of front wheels of a motor vehicle and rear-axle steering for adjusting a wheel steering angle of rear wheels of a motor vehicle. If a serious functional impairment occurs in the front-axle steering or rear-axle steering, so that the associated wheels are no longer steerable, movement of the rack of the impaired steering is advantageously damped, especially if the rack is freely movable. Advantageously, this reduces the steering influence due to the defective steering. In particular, it is provided that a control unit assigned to the steer-by-wire steering system generates a further control signal for controlling a short-circuit circuit of the electric motor of the steering actuator of the defective steering, wherein phases of the electric motor are short-circuited by the control with the further control signal and thus a movement of the rack of the defective axle steering is damped.

According to a further aspect, it is generally provided that a movement of an impaired axle steering is damped, in particular to avoid externally forced adjustment of unwanted wheel steering angles of wheels of the impaired axle steering. In particular, the movement of the impaired axle steering is advantageously damped when a wheel steering angle is set that is favourable for a steering demand. In particular, the functional axle steering is used to implement the steering demand. Advantageously, the functional axle steering can be supported by targeted brake interventions, introduced drive torques and/or other control interventions. In particular, it is provided for damping to exert a significant damping torque on the electric motor of the steering actuator of the steer-by-wire steering system, preferably by short-circuiting the electric phases of the electric motor. The resulting damping force is advantageously used to keep the wheel steering angles of the impaired axle steering constant, in particular the wheel steering angles of the front road wheels in the case of defective front-axle steering, in particular so that the motor vehicle can be steered by means of the rear-axle steering.

Advantageously, with this embodiment variant, the motor phase short circuit is activated by the control unit, in particular by a driving condition determination device, more particular by a vehicle dynamics control system, which advantageously detects the condition of the motor vehicle and steers it after the failure of the axle steering affected by a malfunction. If additional damping is used, in particular by means of a motor phase short circuit, unintentional steering movements of the no longer specifically steerable wheels are advantageously braked by dynamic lateral forces, in particular by the friction and the generated damping. Advantageously, this effect can limit disturbance reactions of the still functional axle steering, in particular the functional rear-wheel steering, wherein advantageously slow steering by means of alternative steering by means of the brakes or the drive is still possible and can advantageously be used purposefully. As a result, the controllability of the motor vehicle in the event of a fault in the steering system can advantageously be further improved. This proposed embodiment can be particularly useful in the case of emergency braking, during which the lane is to be maintained despite a defective steering system, or in the case of a slow evasive movement. Advantageously, the control unit detects a failure of an electric steering actuator of the front-axle steering and activates the phase short circuit on its electric servo motor, so that advantageously the wheel steering angle of the front wheels is fixed. The control unit then advantageously transmits reference position information to the rear-axle steering on the basis of a measured steering wheel position.

In particular, it is also provided that damping of the defective axle steering and an alternative steering function, in particular by targeted braking of wheels of the motor vehicle and/or by steering the still steerable wheels of the functional axle steering, work in parallel. In this case, the damping function is advantageously switched on and off in a targeted manner in order to be able to indirectly adjust the desired wheel steering angle and thus further improve steering control.

In particular, it is provided that braking of the motor vehicle to a standstill is carried out by means of wheel-specific slip control. In this way, an improved deceleration process can be realized. If there is no possibility of wheel-specific slip control, it is advantageously provided that the braking potential of the wheel with the lowest braking potential is used as the brake reference value. In this way, it is advantageously avoided that a wheel locks during braking and thus the path of the vehicle becomes more difficult to control.

Furthermore, it is advantageously provided that when starting the generator mode, all other steerable axles of the motor vehicle follow a reference trajectory to support the safe braking process.

An advantageous embodiment of the method provides that at least two phases of the electric motor of the steering actuator are electrically conductively connected to each other. Advantageously, a braking or damping effect can already be achieved in this way.

In particular, it is provided that the at least two phases of the electric motor are short-circuited to each other to connect the at least two phases of the electric motor electrically conductively to each other. This short-circuiting has the advantage that a comparatively simple and thus cost-effective realization of the process is possible. In addition, a damping or braking effect can be achieved very quickly in this way.

An advantageous aspect provides that all phases of the electric motor are electrically conductively connected to each other. In the event of a short circuit, all phases of the electric motor are then advantageously short-circuited. Advantageously, the damping or braking effect is increased by the fact that all phases of the electric motor are electrically conductively connected to each other.

As a further advantageous embodiment, it is provided that the electric motor is operated with maximum current drain in the generator mode. The maximum current drain refers to the technically maximum possible current drain for the specific electric motor used. As a result of the fact that the electric motor is operated in generator mode with maximum current drain, the damping or braking effect of the electric motor is advantageously further increased.

According to a further advantageous embodiment, the electricity generated in the generator mode is stored in an energy storage device. Advantageously, the electric motor is thereby less heavily loaded, especially compared to short-circuiting of the phases, and damage to the electric motor in the generator mode can be better avoided. In addition, the electrical energy converted by the electric motor and supplied to an energy storage device can be used, in particular to supply other assistance systems with electrical energy if required, which can be used for safe stopping of the vehicle. In particular, an accumulator and/or a capacitor is provided as energy storage.

It is further advantageously provided that the electricity generated in the generator mode is converted into heat by means of ohmic resistors. Advantageously, with this embodiment there is no problem that an energy storage device can no longer absorb energy. In particular, such an option of converting the electricity generated by the electric motor into thermal energy by means of ohmic resistors may be provided in addition to the option of storing the generated electricity in an energy storage device.

In a further advantageous embodiment of the method, the electric motor is cooled in the generator mode, in particular when short-circuiting of the phases of the electric motor is provided. Damage to the electric motor and thus also a failure of the damping or braking effect of the electric motor can thus advantageously be better avoided.

In particular, it is provided that the electric motor is operated in the special operating mode when the existence of a predefined serious exceptional state has been detected. In this respect, the special operating mode is in particular an emergency operating mode. In particular, such a serious exceptional state exists if the steering actuator no longer reacts or does not react in a specified manner to specified steering commands, in particular neither to steering commands given by a control unit of the motor vehicle in an autonomous driving mode of a motor vehicle nor to steering commands given by a driver by means of the steering input device in a manual or semi-manual driving mode of a motor vehicle. If steering commands can either still be specified by a control unit or can be specified by a driver by means of the steering input device, a change to the special operating mode should preferably be avoided, unless in particular other criteria for the existence of the serious exceptional state are met. This may be the case, in particular, if the motor vehicle has had an accident but has not yet come to a standstill.

For detection of the predefined serious exceptional state, at least one of the following states is advantageously evaluated: a vehicle position, a vehicle speed, a vehicle inclination, a projected path, a vehicle impulse, a temperature of the steering actuator, a torque of the steering actuator, a rotational speed of the steering actuator, a torque of a steering input command, a direction of rotation of a steering input command, a rotational position of a steering input command. In particular, the states are detected and evaluated continuously or at short intervals, which are particularly in the millisecond range. The evaluation is carried out in particular to the effect that a serious technical defect and/or an accident situation and/or a lack of reaction of the driver, for example due to unconsciousness, is recognized as a predefined serious exceptional state with the maximum certainty.

The further proposed steer-by-wire steering system for a motor vehicle comprises a steering input device by means of which a steering command can be specified, and a steering gear including a steering actuator with an electric motor and a coupling element, wherein the electric motor of the steering actuator is designed to receive a control signal to convert a steering command into a steering movement of steerable wheels of a motor vehicle and to covert the received control signal into a mechanical movement of the steering actuator, wherein the steering actuator is designed to act on the coupling element to implement the steering command, and wherein the steer-by-wire steering system is designed to be operated according to a method designed according to the disclosure, wherein the method has in particular the features described above individually or in combination. Thus, the electric motor of the steering actuator of the steer-by-wire steering system is particularly designed to be operated in a generator mode in a special operating mode of the steer-by-wire steering system and thus in particular to damp or brake a movement applied to the electric motor via the steering gear in the special operating mode. The steerable wheels of a motor vehicle are thus advantageously opposed by a resistance, whereby an uncontrolled movement of the steerable wheels in a exceptional state is prevented or at least reduced. The electric motor of the steer-by-wire steering system is in particular a synchronous motor, in particular a permanent magnet synchronous motor. In particular, it may be provided that the electric motor comprises a plurality of winding groups, each of which can be controlled separately via corresponding phases. Preferably, the electric motor is designed such that it can be operated both with individual winding groups and with all winding groups in the generator mode. Advantageously, the damping or braking effect of the electric motor can be controlled in the special operating mode in this way. For maximum braking effect, the electric motor is advantageously operated with all winding groups in the generator mode.

In particular, it is provided that a control unit is assigned to the electric motor of the steering actuator, wherein the control unit is designed to control the electric motor for the operation of the steer-by-wire steering system. Advantageously, the steer-by-wire steering system comprises this control unit. The control unit is in particular a suitably set up microcontroller unit. In particular, the control unit may be included in the power pack of the electric motor. Advantageously, the control unit is designed to put the electric motor in the generator mode in the special operating mode.

Further advantageously, the steer-by-wire steering system comprises a circuit arrangement which is designed to connect phases of the electric motor electrically conductively to each other. Advantageously, for this purpose the circuit arrangement comprises controllable switching elements, in particular MOSFETs. In particular, it is further provided that the circuit arrangement is designed to electrically conductively connect all phases of the electric motor to each other. Furthermore, it is provided in particular that the circuit arrangement is designed to electrically short-circuit phases of the electric motor, in particular all phases of the electric motor. In particular, it is provided that the phases of individual winding groups of the electric motor, in particular the phases of all winding groups of the electric motor, can be electrically conductively connected to each other by means of the circuit arrangements.

In particular, as an embodiment variant for short-circuiting of the phases it is provided that the circuit arrangement is designed to connect the phases of the electric motor electrically conductively to each other in such a way that the electric motor is operated in a generator mode and electricity generated therein is supplied to an energy storage device and/or is converted into thermal energy by means of ohmic resistors. In particular, an accumulator or a capacitor, in particular a high-performance capacitor, is provided as energy storage, wherein the energy storage may be included in particular in the steer-by-wire steering system. In particular, it may also be provided that electricity generated by the electric motor in the generator mode is supplied to an energy storage device of the motor vehicle.

Further advantageously, the circuit arrangement of the steer-by-wire steering system comprises controllable switching elements that connect the phases of the electric motor. Advantageously, the control unit assigned to the electric motor is designed to control these switching elements to trigger the damping or braking effect of the electric motor in the special operating mode. In particular, it is provided that the switching elements are self-conducting semiconductor switching elements, in particular self-conducting MOSFETs. Advantageously, a serious exceptional state, which no longer supplies the gate terminals of the MOSFETs with a current for blocking the MOSFETs, results in the phases of the electric motor being electrically conductively connected to each other, in particular in the phases of the electric motor being short-circuited.

A further advantageous aspect of the steer-by-wire steering system, the electric motor comprises a cooling device. The cooling device may be either passive or active. Advantageously, the cooling device provides improved dissipation of the heat energy generated in the electric motor in the case of short-circuiting of the phases of the electric motor.

Furthermore, a motor vehicle with a steer-by-wire steering system according to the disclosure is proposed, wherein the steer-by-wire steering system has in particular the aforementioned features individually or in combination.

In the different figures, the same parts are usually provided with the same reference signs and are therefore sometimes explained only in connection with one of the figures.

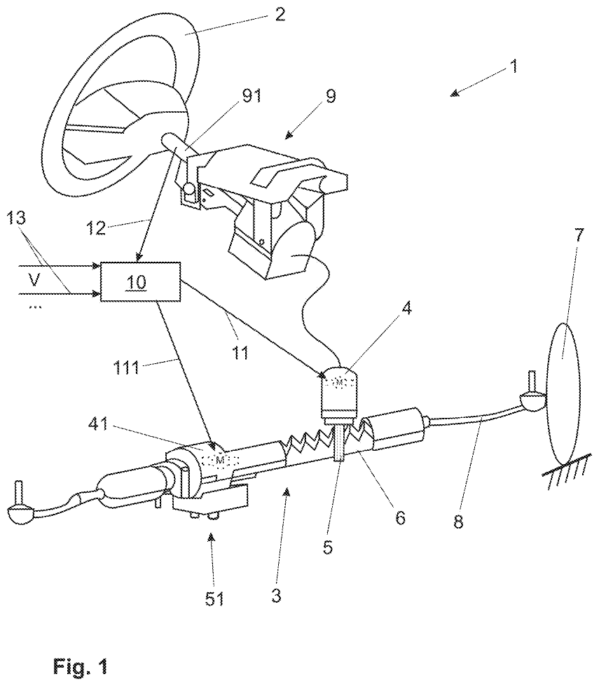

In FIG. 1 an exemplary embodiment of a steer-by-wire steering system 1 designed according to the disclosure is shown schematically. The steer-by-wire steering system 1 comprises a steering column 9 with a steering shaft 91, wherein a steering input device 2 in the form of a steering wheel is arranged non-rotatably at one end of the steering shaft 91. A driver can specify a steering command by means of the steering input device 2. The steering input device 2 can be rotated in a known manner to introduce a torque as a steering command into the steering shaft 91. A feedback actuator not explicitly designated in FIG. 1 can provide a steering resistance torque to convey a natural feel of the steering.

Furthermore, the steer-by-wire steering system 1 in this exemplary embodiment comprises a steering gear 3 with a steering actuator 5 in the form of a steering pinion and a coupling element 6 in the form of a rack. The steering actuator 5 comprises an electric motor 4, which may be in the form in particular of a three-phase permanent magnet synchronous motor. With the electric motor 4, the steering actuator 5 can be driven to act on the coupling element 6 and to trigger a steering movement of steerable wheels 7, which are connected in particular via tie rods 8 to the coupling element 6. The tie rods 8 themselves are each connected to a steered wheel 7 in a known manner by steering knuckles.

A steering command detected by sensors not explicitly shown in FIG. 1 is sent to a control unit 10, in particular an ECU (ECU: Electronic Control Unit), as a detected steering command 12 in a normal operating mode of the steer-by-wire steering system. The control unit 10 generates a control signal 11, in particular based on the received detected steering command 12. The control signal 11 is sent to the electric motor 4 of the steering actuator 5 for converting the detected steering command 12 into the steering movement of the steerable wheels 7. The electric motor 4 thereupon converts the received control signal 11 into a rotational movement of the steering actuator 5, wherein the steering actuator 5 converts this rotational movement into a corresponding translational movement of the coupling element 6, which leads to adjustment of the steering angle of the steerable wheels 7.

The electric motor 4 is also designed to be operated in a generator mode in a special operating mode different from the normal operating mode. In this generator mode, the electric motor 4 does not ensure a conversion of a control signal 11 into a mechanical movement of the steering actuator 5 and thus a steering movement of the steerable wheels 7. Instead, in the generator mode the electric motor 4 damps a movement of the steerable wheels 7 which is applied to the steerable wheels 7 from the outside. Thus, normally, when the electric motor 4 is not controlled, a movement of the steered wheels 7 would lead to a longitudinal displacement of the coupling element 6 in the form of a rack, which in turn would lead to a rotation of the steering actuator 5 in the form of a steering pinion and a rotation of the rotor of the electric motor 4. If control of the steered wheels 7 is not possible, this would result in the steerable wheels 7 being able to change the steering angle randomly without significant resistance, which could lead to a safety-critical driving situation.

By operating the electric motor 4 in a generator mode, this behaviour is advantageously prevented or at least reduced, because in the generator mode the electric motor 4 acts like a brake. A rotated steering angle of the steerable wheels 7 can thus advantageously be maintained, in particular until the corresponding vehicle has safely come to a standstill.

Alternatively or additionally, the steer-by-wire steering system 1 may comprise a further steering actuator 51 with a further electric motor 41, wherein the control unit 10 sends a further control signal 111 to the further electric motor 41 of the further steering actuator 51 to adjust a steering angle of the steerable wheels 7 in a corresponding manner.

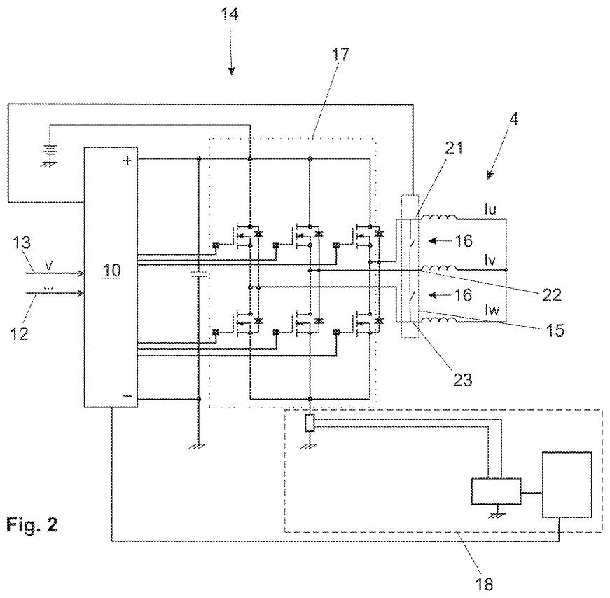

An embodiment for the electric motor 4 and its control is shown schematically in FIG. 2. FIG. 2 shows a circuit arrangement 14 with the control unit 10, an inverter 17 containing three-half-bridges by means of which the phases 21, 22, 23 of the electric motor 4 are controlled, and a feedback branch 18, via which the control unit 10 receives feedback about the currents applied to the phases. In addition, a circuit arrangement 15 is provided, which is designed to connect the phases 21, 22, 23 of the electric motor 4 electrically conductively to each other. For this purpose, the circuit arrangement 15 comprises controllable switching elements 16, in particular self-conducting MOSFETs, connecting the phases 21, 22, 23 of the electric motor 4. The circuit arrangement 15 and the switching elements 16 are shown only schematically in FIG. 2.

By means of the switching elements 16, the phases 21, 22, 23 of the electric motor 4 can be electrically short-circuited in the special operating mode. In an alternative embodiment, it may be provided to connect the phases 21, 22, 23 of the electric motor 4 in such an electrically conductive manner that the electric motor 4 can be operated in a generator mode, wherein the electrical energy generated in the generator mode is either supplied to an energy storage device, in particular a battery, for storing the electrical energy, or is converted into thermal energy by means of ohmic resistors. The control of the switching elements 16 of the circuit arrangement 15 is carried out by means of the control unit 10.

The control unit 10 is in this exemplary embodiment is in particular also designed to monitor whether a predefined serious exceptional state has occurred. For this purpose, the control unit 10 receives a plurality of state signals 13 detected by sensors and evaluates them. The state signals can be provided in particular by devices of other driver assistance systems, in particular by an ESP system (ESP: Electronic Stability Program) and/or a pre-crash system. The state signals 13 advantageously relate to the vehicle as such, in particular a vehicle position, a vehicle speed, a vehicle inclination, a projected path and/or a vehicle impulse, and the technology of the steer-by-wire steering system 1, in particular a temperature of the steering actuator 5, a torque of the steering actuator 5 and/or a rotational speed of the steering actuator 5. These state signals 13 are advantageously compared with predefined variables and it is checked whether these are within specified intervals and/or do not exceed or fall below predefined threshold values. As further states the following are advantageously checked: the detected steering commands 12, in particular with regard to a torque of a steering input command 12, a direction of rotation of a steering input command 12 and/or a rotational position of a steering input command 12. If a predefined serious exceptional state is detected by the evaluation of the detected state signals 13 and the detected steering commands 12, in particular a lack of steering commands when leaving a specified path, the steer-by-wire steering system 1 switches from the normal operating mode, in which steering commands are implemented in the usual manner by the steer-by-wire steering system 1, to the special operating mode in which the electric motor 4 is operated as a brake in the generator mode.

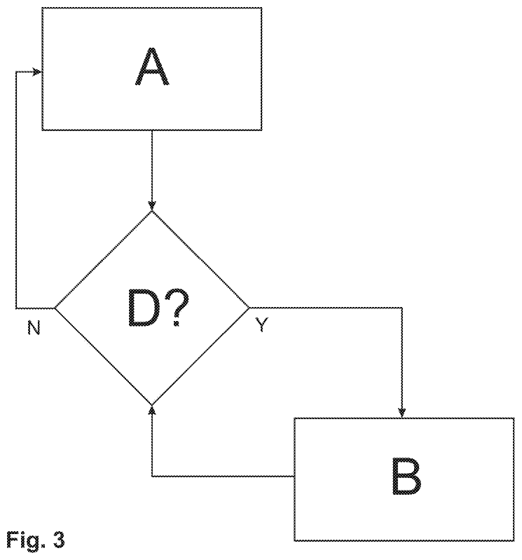

An exemplary embodiment of a method for operating a steer-by-wire steering system of a motor vehicle is shown greatly simplified in FIG. 3. The steer-by-wire steering system may be in particular in the form as explained with reference to FIG. 1. In a normal operating mode (A), specified steering commands are detected and corresponding control signals for converting the detected steering commands into a steering movement of steerable wheels of the motor vehicle are sent to the electric motor of the steering actuator of the steer-by-wire steering system, wherein in the normal operating mode (A) the electric motor drives the steering actuator of the steer-by-wire steering system according to the control signals received, and the steering actuator adjusts the wheel steering angle of the steerable wheels of the motor vehicle via the coupling element of the steer-by-wire steering system. The normal operating mode (A) may comprise several operating modes, in particular a manual driving mode, in which a driver specifies steering commands by means of a steering input device, and an autonomous driving mode, in which the vehicle is controlled autonomously without steering intervention by the driver.

During the normal operating mode (A), it is constantly checked whether a serious emergency condition D exists. If this is not the case (branch “N” in FIG. 3), the steer-by-wire system remains in the normal operating mode (A). If, on the other hand, a serious exceptional state D is detected (branch “Y” in FIG. 3), the steer-by-wire steering system switches to the special operating mode B and the electric motor no longer drives the steering actuator, but the electric motor damps the movement of the steering actuator in the generator mode. In the meantime, however, it is also constantly checked whether a serious exceptional state D exists. If this is still the case (branch “Y” in FIG. 3), the steer-by-wire steering system remains in the special operating mode B. Otherwise (branch “N” in FIG. 3) the steer-by-wire steering system switches back to the normal operating mode (A). In particular, it is also provided that if a serious exceptional state D has been detected the motor vehicle is brought to a controlled stop, in particular using other assistance systems of the motor vehicle. Due to the special operating mode, a further driving profile of the motor vehicle can be better predicted for further driver assistance systems, so that passive safety systems, such as airbags installed in the vehicle, can be better prepared for a possible crash and vehicle occupants can thus be better protected.

The exemplary embodiments shown in the figures and explained in connection with them serve to explain the disclosure and are not limiting for it.

The methods and systems of the present disclosure, as described above and shown in the drawings provide for a steer-by-wire steering system of a motor vehicle with superior properties including increased reliability and ease of use. While the apparatus and methods of the subject disclosure have been showing and described with reference to embodiments, those skilled in the art will readily appreciate that changes and/or modifications may be made thereto without departing from the spirit and score of the subject disclosure.

### LIST OF REFERENCE NUMERALS

1 Steer-by-wire steering system
2 Steering input device
3 Steering gear
4 Electric motor
41 Electric motor
5 Steering actuator
51 Steering actuator
6 Coupling element
7 Steerable wheel
8 Tie rod
9 Steering column
91 Steering shaft
10 Control unit
11 Control signal
111 Control signal
12 Detected steering command
13 Detected state signals
14 Circuit arrangement
15 Circuit arrangement
16 Switching element of the circuit arrangement (15)
17 Inverter
18 Feedback branch
21, 22, 23 Phase of the electric motor (4)
A Normal operating mode
B Special operating mode
D Serious exceptional state
N No serious exceptional state detected
Y Serious exceptional state detected

What is claimed is:

1. A method of operating a steer-by-wire steering system of a motor vehicle to convert a steering command into a steering movement of steerable wheels of a motor vehicle comprising:
sending a control signal to an electric motor of a steering actuator;
converting the received control signal into a mechanical movement of the steering actuator by the electric motor, wherein the steering actuator acts on a coupling element, and wherein the electric motor is operated in a generator mode.

2. The method of claim 1, wherein in the generator mode at least two phases of the electric motor are electrically conductively connected to each other.

3. The method of claim 2, wherein the at least two phases of the electric motor are short-circuited with each other in order to connect them to each other electrically conductively.

4. The method of claim 2, wherein all phases of the electric motor are electrically conductively connected to each other.

5. The method of claim 1, wherein the electric motor is operated with maximum current drain in generator mode.

6. The method of claim 1, wherein electricity generated in generator mode is stored in an energy storage device.

7. The method of claim 1, wherein electricity generated in generator mode is converted into heat by means of ohmic resistors.

8. The method of claim 1, wherein the electric motor is cooled in generator mode.

9. The method of claim 1, wherein, the electric motor is operated in a special operating mode when existence of a predefined serious exceptional state has been detected.

10. The method of claim 9, wherein to detect the predefined serious exceptional state at least one of the following is evaluated: a vehicle position, a vehicle speed, a vehicle inclination, a projected path, a vehicle impulse, a temperature of the steering actuator, a torque of the steering actuator, a rotational speed of the steering actuator, a torque of a steering input command, a direction of rotation of a steering input command, a rotational position of a steering input command.

11. A steer-by-wire steering system for a motor vehicle comprising:
a steering input device configured to specify a steering command;
a steering gear comprising a steering actuator, an electric motor, and a coupling element, wherein the electric motor is configured to receive a control signal and to convert the received control signal into a mechanical movement of the steering actuator in order to convert a steering command into a steering movement of steerable wheels of a motor vehicle, and wherein the steering actuator is configured to act on the coupling element to implement the steering command.

12. The steer-by-wire steering system of claim 11, wherein the electric motor is assigned a control unit, wherein the control unit is configured to control the electric motor for the operation of the steer-by-wire steering system.

13. The steer-by-wire steering system of claim 11, further comprising a circuit arrangement of the electric motor wherein phases of the circuit arrangement a connected to each other electrically conductively.

14. The steer-by-wire steering system of claim 13, wherein the circuit arrangement comprises controllable switching elements connecting the phases of the electric motor.

15. The steer-by-wire steering system of claim 14, wherein the switching elements are self-conducting semiconductor switching elements.
